(19) United States
(12) Patent Application Publication
(10) Pub. No.: US 2002/0061497 A1
(43) Pub. Date: May 23, 2002

(54) Plastic foam cutting system and method

(76) Inventors: Linda G. Boudreaux, Mobile, AL (US); Rodney G. Boudreaux, Mobile, AL (US)

Correspondence Address: GREGORY M. FRIEDLANDER & ASSOCIATES, P.C., 11 SOUTH FLORIDA STREET, MOBILE, AL, 36606-1934, US

(21) Appl. No.: 09/840,318

(22) Filed: Apr. 23, 2001

Related U.S. Application Data
(60) Provisional application No. 60/114,870, filed on Jan. 6, 1999.
(60) Provisional application No. 60/099,006, filed on Sep. 3, 1998.

(51) Int. Cl. G09B 19/00

(52) U.S. Cl. 434/96

(57) ABSTRACT

The invention consists of a cutting system comprising a hot wire cutter which is removably wired to table upon which a spindle is mounted for containing a script template in compartments, one for each letter. The template is color coded, with one color being for letters of each of at least two separate forms (one being capitalized and one being small). Other coded letters include those letters for joining on the right and those for joining on the left, it being a part of this invention that the letters of the template would interlock, locking on the left, the right or both and having color coding of each letter in order to simplify selection. The color coding and organization system also is for a template or set of characters equipped with connecting means in order that the set can be used to make forms to cut to order script names or words. The characters have, in at least two horizontal plane, a connecting means allowing the characters to be joined together horizontally the connecting means being incorporated into the forms made or fitting non-obtrusively into the forms made. The template is more specifically directed to providing forms for a script alphabet. At least one character in the set is used for more than letter formation and hence a system is disclosed for maintaining the separation of the letters. Also disclosed is a device for treating and aligning for mounting cut letters, particularly those made out of plastic foam onto uneven surfaces.

### PRIORITY

This patent is a continuation of Provisional Patents: No. 60/114,870 filed Jan. 6, 1999, No. 60/099,006 filed Sep. 3, 1998 and Utility patent Ser. No. 09/388,793 filed Sep. 2, 1999.

### BACKGROUND OF INVENTION

1. Field of Invention

The present invention relates to a method and process for making plastic foam cutout forms.

2. Prior Art

U.S. Pat. No. 3,270,452 issued Sep. 6, 1966, to A. N. D'Elia, et al. shows the use of a base attachment utilizing male and female connecting means. This use does not lend itself readily to use as a template system for making cutouts, without having a base to every character.

The base cannot be separated from the characters. The use of this system necessarily leaves an undesirable base. It fails to envision the use of varied attachment points in order to allow for construction of characters in any combination without a base for every character. It does not envision nor make practical the use of the formed characters as a template for making cutouts or tracings. It also fails to provide for attachment to the material to be cut, for multiple horizontal attachment points.

Similarly, U.S. Pat. No. 3,728,800 issued Apr. 24, 1973 to Magram and U.S. Pat. No. 3,391,476 issued Jul. 9, 1968 to Sher show words, similarly mounted in a fashion so they may be connected in varying degrees of complexity. In these patents, a tracing or cutting made would not yield any variety of patterns or cutouts.

U.S. Pat. No. 2,716,827 issued Sep. 6, 1995 to L. M. Mixter shows the use of wire to make floral designs and also envisions a base made of aerated plastics. Again, no sufficient method is disclosed for the production of stylized or individualized cutouts or bases from a variable pattern or template.

U.S. Pat. No. 3,440,750 issued Apr. 24, 1979 to J. Toth, et al. shows a use for aerated plastics or Styrofoam, T. M., type cutouts but again, fails to show a method for production of the cutouts themselves.

U.S. Pat. No. 3,017,487 issued Jan. 16, 1962 to F. P. Priestly and U.S. Pat. No. 3,895,438 issued Jul. 27, 1975 to Burkepile, et al. show various equipment used for cutting Styrofoam and similar materials. Although both envision the use of the invention to cut Styrofoam neither discloses the use of a template as a method for making patterns for these cutouts.

Other prior art includes templates having characters similar or identical to the shapes of the characters set out herein which are subject to Copyrights, those templates not being coded by color nor being in all respects necessarily identical to those disclosed herein.

References Cited in the file of this patent

United States Patents

3,270,452—A. N. D'Elia, et al., Sep. 6, 1966

2,716,827—L. M. Mixter, Sep. 6, 1955

3,728,800—David Magram, Apr. 24, 1973

3,391,476—M. A. Sher, Jul. 9, 1968

3,440,750—J. Toth, et al., Apr. 29, 1969

3,017,487—F. P. Priestly, Jan. 16, 1962

3,895,438—Ivan H. Burkepile, et al., Jul. 22, 1975

### GENERAL DISCUSSION OF THE INVENTION

A series of vertical and horizontal members for holding letters at a predetermined distance from one another and at a predetermined distance from a structure and wherein one set of letters may be at a greater distance from the structure than others and in order to accomplish this has a board with spacers which fit between the letters and which serve to hold the letters at a predetermined point possibly with graduations marked on the structure in order to set the distance of separation and wherein the spacers are mounted onto a mounting board which may have graduated in inches or metric measurement markings so as to control the raising of one letter from another and for the letters from a surface in which they are mounted. The spacers 312 would also have a means for fixing them to the letters and particularly for Plastic foam letters would have a means for penetrating the Plastic foam in order to grip them and hold them in place.

An additional step in the treatment of the letters for permanizing the letters would be to provide a table with pins to hold the letters in place, but otherwise elevated by the back side while paint was poured over the front and sides. This table would preferably have two specialized features. First, it would have a holder for elevating the letter over a tray which tray would secure the back of the letters as by pins. Second, it would have a basin to allow unused paint or treating solution to collect and preferably drain into a can for recycling. Finally, it would have a motor for vibrating the tray or the table and tray so that the solution would be evenly distributed over the table as shown in FIG. 21.

The invention consists of a cutting system. The cutting system comprises a novel cutter, a method of treating letters, a template product and tools for utilizing the prepared letters.

The cutter is a novel hot wire cutter which has an arm which is removably wired to a table. A spindle having a rack may be fitted beside or on top of the table. The rack has a series of compartments organized vertically and horizontally for organizing and containing a script template. Letters are held in individualized compartments or they may be grouped together.

The template, shown in it's entirety in FIG. 1, is color coded. As can best be seen by reference to FIG. 6, the color coding has a middle left color 1b and a middle right color 1a which are preferably the same so that the cooperating male and female members may be connected. The compartmentalization allows for color coded letters to be separated and located according to their coding.

A dropping color 1c and rising color 1d are similarly coordinated, usually by being the same so that the similar members may be connected. Lower left 1f and lower right 1e colors are also present so that these combinations may be aligned. In the preferred embodiment all of these left and right combinations may be interchangeable. There may be an upper left 1h and upper right 1g coloring for letters which join at one or more level above the middle level as shown in FIG. 1 items 132, 133, 135 and 113 by way of example.

The entire letter or part thereof may be color coded using these types of reference colors and coding may vary for capitalized and small letters. Other coded letters include those letters for joining on the right and those for joining on the left, it being a part of this invention that the letters of the template would interlock, locking on the left, the right or both and having color coding of each letter in order to simplify selection. The color coding and organization system is for a template or set of characters equipped with connecting means in order that the set can be used to make forms to cut to order script names or words. The characters have, in at least two horizontal plane, a connecting means allowing the characters to be joined together horizontally the connecting means being incorporated into the forms made or fitting non-obtrusively into the forms made. The template is more specifically directed to providing forms for a script alphabet. At least one character in the set is used for more than letter formation and hence a system is disclosed for maintaining the separation of the letters.

The cutting table itself has several novel features, not present in the prior art. The removable cutting arm 200 may be fitted into a socket which is, in turn, in contact with a grounding wire by way of ground lead. This allows the arm to be popped in and out so that the the table is portable. A wire, connected to the arm by way of a spring hooked to an opening in the arm is connected to a power source to allow the wire to be heated.

There is also taught a unique wiring mechanism providing for a longer arm as well as variable temperature. In order to allow this greater portability, the hot wire for the cutter travels from a transformer to a receptacle. A plug fits into the receptacle in order to operationally to allow the passage of electricity through an insulated wire through the arm to a conductive spring. This spring attaches to the Nichrome or similar material cutting wire which runs down to the ground for the system. The arm itself is insulated from the internal wire. The point where the spring joins the insulated wire or where the spring joins the cutting wire is a removable connection also. This allows for the arm to be disconnected from both the cutting wire and from the receptacle so that it may be completely removed.

One major advance over the known prior art is the advanced cutting system for simplifying the cutting of script or block names from interlocking templates utilizing a wire cutter including a table specifically designed for this purpose and for containing letters of appropriate size without interfering with the view. In addition, since a script template, as previously described, is used which has multiple versions (in some cases four) of a single letter, a color coding system has been developed as a part of the system to allow easy association of the letters and easy selection of the letters. Association is the joining of the proper version of a letter in the series of letters forming a word. The selection is the selection of the letters from the trays which form a part of the spindle upon which the letters are held.

The present invention utilizes interchangeable characters, together forming a template, in order to form patterns which can, in turn, be used to make stabilized and individualized cutouts or tracings. As can be readily seen by examination of the character set in the application drawings, the characters are not designed to be identical to the end product. Instead, the invention is directed to the use of characters or pieces which can be used to make a form to be traced which form, when traced or used as a pattern for cutting, in turn, results in a tracing cutout of appropriate shape. The improvement includes a method of organization and coding of the existing characters in order to simplify their use.

The connecting means are incorporated into the words or patterns formed when joined. A system of common numbering or coloring which ties corresponding parts is taught.

The present invention envisions the use of a set of characters. In this set there may be several different characters forming the same letter, but with differently located connecting means so that any conceivable combination is possible using any letters or character shapes. This requires the production of similar but not identical characters which possesses different connecting points.

One shape or letter may have two forms, one character form would be shaped for one type of connection to the adjacent pieces and others would apply to a different connection point for other adjacent pieces in order to have a complete set of characters. This also requires that there be different shaped characters which, when traced for cutting, result in a cutout showing a desired character.

The preferred embodiment envisions the use of hard physical characters with a hot wire type cutter.

This is one of the several methods to deal with and easily cut out materials. It can be easily seen, however, this method could be applied to more complicated methods of cutting such as a separate tracing means or stylus and cutter so that the tracer is connected indirectly with the cutting equipment for safety or for ease of use. In this way, the cutter could be either electrically or mechanically and rigidly fixed to the cutter. Similarly, the letters when electronically connected could be traced by action on the electronically generated form so that the use of mechanical pieces would no longer be required. The cutting could then be directed separately by process.

This invention also envisions the use of recesses and openings wherein a cutting tool or stylus directing a cutting tool may follow the pattern created to remove internal portions of any characters so that the cutter may be more easily operated and not be lifted and reinserted for any given pattern.

The table may be modified in order to have slots cut into it into which a exhaust fan would mounted in order to draw the fumes directly from under the wire under the unit and possibly into a filter.

In addition the control switches may be recessed and the carrying handles may be recessed in order to prevent these from being damaged during shipping.

The sides of the slots may need to curve downward or be rounded in order to prevent the Styrofoam to be cut from sticking or it may have to have some non-stick or fire retardant cover.

Finally, the invention discusses the application of a method of directing an automated cutter using scripted letters of the types set out herein and connected as set out herein in order to direct a cutting wire or similar cutter to create signs of the type disclosed.

In the preferred embodiment, an attaching means, in the form of pin holes and pins to fit therein is provided in order to allow the invention form to be mounted fixedly on a table for use with a stylus or directly onto the material to be cut.

The present invention also envisions the use of connectors along certain planes. Intentionally taking the character connecting means out of the plane resulting in crooked lettering or an alphabet with different mounts would not change the basic thrust of the invention. This specification also discloses a device utilized for mounting letters cut along even or uneven surfaces. In order to better understand this device, it should be understood that the technology disclosed herein may be used in order to make large letters which could be used for manufacturing signs in a commercial setting. In order to do this, the following steps would be taken. First, the letters would be cut for the sign from a predetermined list of letters in order to make the word. The spacing disclosed bar is then used in order to space the letters at the appropriate distance from one another. Finally, the mounting bar is mounted onto the surface onto which the sign is to be placed. The distance spacers allow for the distance from the sign to the surface behind it to be determined. In order to have the letters at the desired distance (either the same distance from an uneven surface for normal mounting or at staggered distances for effect) the spacing bars are adjusted. At this point, permanent spacing may be added to which the letters themselves will be attached to the uneven surface. For even surfaces, the distance spacers are unnecessary except where a staggered effect is desired.

Since the spacing of letters varies according to the letter, there is a code for specific letters allowing spacers of different sizes to be used or allowing more spacers of a single size to be used. The spacer to letter ratio is preferably standardized for specific letters having specific spacing requirements. Again, these may be varied for different effects. The system described herein allows for plastic foam or aerated foam, such Plastic foam to be used in order to produce high quality signs which may be mounted to uneven or even surfaces without skilled labor or excessive measuring. The spacer mounting device preferably uses levels and vertical and horizontal extensions to allow for multiple lines of text or text at staggered levels. Specific gradations are noted on all extensions and spacers in order to allow the user to know where, specifically, spacing will leave the end product. In this way, the letters may be drawn out electronically or by hand and the sign thereby shown can be easily duplicated and mounted.

Although only one attachment is shown in the preferred embodiment, it can be easily seen that this invention could have the attachments for any given character in a different position to obtain a given result or appearance and would similarly be encompassed by the disclosure herein.

An advantage of this invention is that it allows someone with limited ability access to making stylized name cutouts without extensive training or experience.

Another advantage of this invention is that it is directed to providing a reusable and variable form for making individualized cutouts.

The letters may be treated as discussed herein to weather proof them. The next step is to align the sign constructed of either individual or joined letters prepared by the process along with any other shapes, such as logos cut out of plastic foam, utilizing the process set forth above at the desired locations, usually level relative to the earths gravitational pull along the side of a building or a roof.

Once the letters are put in place they are maintained there by applying a glue of the type which is disclosed. The glue is preferably a tacky semi slow drying product as opposed to an instant bonding glue in order to allow for the product to be properly positioned but an instant drying glue can be used as long as an alignment mechanism is available to assure that the sign is properly located.

If the leveling device needs to be removed, the letters may be taped in place to allow them to dry without falling off the sign and the tape is removed at the desired point in time.

Excess glue excess sealer or excess paint may be cut away either before the letters are applied or after they are sealed in place the re-sealed and painted as necessary.

Because the letters are much lighter than letters made of other materials they have less of a danger of structural effect on the building and if they are accidentally broken off of the building there is very little chance that they will do harm if they strike a object or person.

It is therefore a purpose of the invention to provide a device for mounting letters so that the letters may be put against a structure for mounting at a predetermined width from one another and at a predetermined height angled from the structure. Once the letters are in place and properly spaced from the structure, it is envisioned that shims would be used behind the letters in order to insure that they remained out at the appropriate location but were still secured to the structure.

As a further purpose of the invention to allow this to be done utilizing Plastic foam letters with the shims behind the Plastic foam would be also Plastic foam the sign could be permanently attached to a building with the letters at different depths from the structure but secured structure and outwardly appearing to be at an even height from the structure or to be at an uneven height for a predetermined visual affect.

In this way, it would be possible to have some letters higher than others in a staggered fashion or in that graduated fashion so that the letters steadily came out depending which arch steadily went in depending on what the direction of the graduation was.

### BRIEF DESCRIPTION OF DRAWINGS

FIG. 1 are views of capital or upper case letters used in connection with the invention described herein and a plan view of lower case letters used in connection with the invention described herein and examples of non-connecting or floating pieces used in connection with the invention described herein.

FIG. 2a is a plan view of a table to be used with the script.

FIG. 3 is a x-sectional view of the table shown in FIG. 2a.

FIG. 4 shows a plan view of a leveling and placement device used for mounting letters.

FIG. 5 shows a flow chart of the process described hereunder for performing automatically the process otherwise described hereunder.

FIG. 6 shows an example of how letters are connected.

FIG. 7-13 shows examples with specified letters and alternative embodiment for the table.

FIG. 15 shows a color coding system used for organizing the templates shown in FIG. 1.

FIG. 16 is a plan view of an alternate device for allowing the mounting of individually cut letters to be mounted on uneven surfaces, but parallel.

FIG. 17 is a view of the spacing shown in FIG. 16 with letters to be mounted in place.

FIG. 18 is a close up view of the spacer shown in FIG. 17.

FIG. 19 is an electrical diagram of the cutter described above.

FIG. 20 is a table for carrying out the process of coating letters.

### DETAILED DESCRIPTION OF THE PREFERRED EXEMPLARY EMBODIMENTS

Template

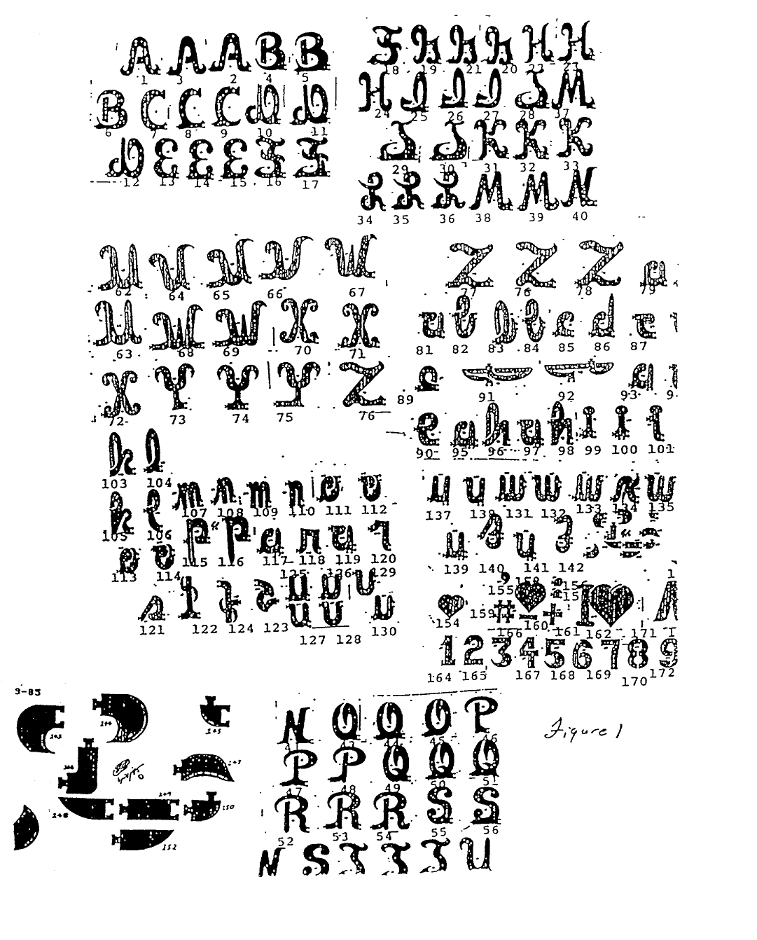

As can best be seen by referenced to FIG. 1 there are a multiplicity of interconnecting pieces or characters (above non-reference numbers 1-172) of any durable material such as wood, plastic or metal. As shown in FIG. 5 each character has one or more linking members or means. In the preferred embodiment, two different basic types of linking members exist, one male (3) and one female (4). The positioning of these linking members is at particularly selected location (5) which varies according to which characters are to be joined. In this way one basic character (1) may have connecting means (2), in different locations (5) according to what characters will be ultimately joined thereto.

As can best be seen by reference to FIGS. 1 and 5 there are three forms for each capital letter. FIG. 1 shows a capital “A” with a right female connector 4. FIG. 2 shows a capital “A” with a left male connector 4 and a right female connector 3. In this way, capital letters may be joined in any position in the script alphabet to other capital letters. This pattern of having three capital letters for each single letter in the alphabet is shown in FIG. 1 in items 1 through 78.

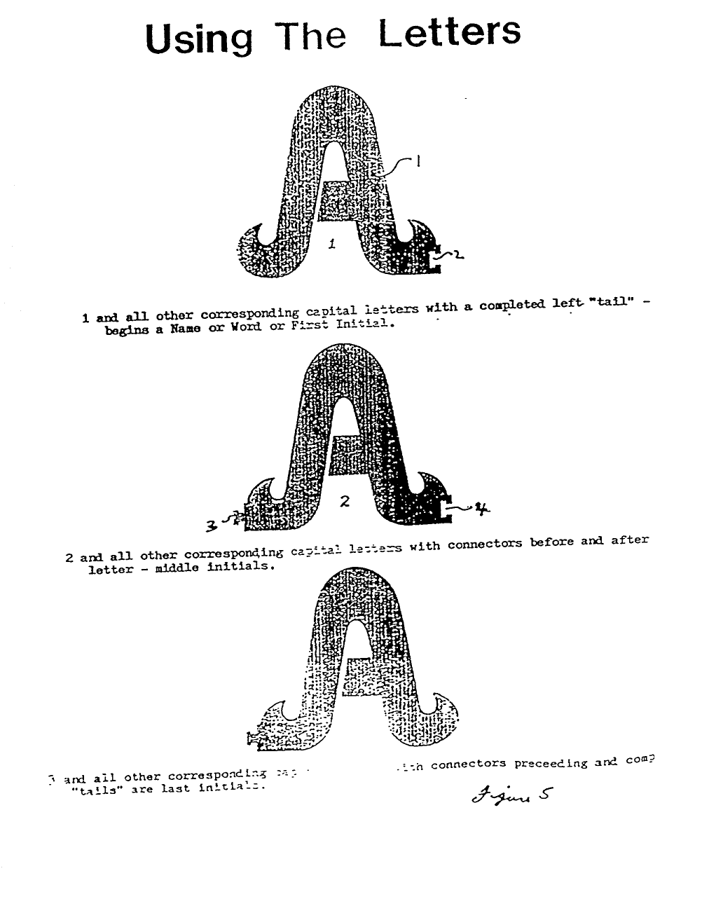

As can best be seen by reference to FIGS. 6, 7, 8, 9, 10, 11, 12 and 13, any given character (1) may be provided with different variations of placement connecting means 3 and 4 and each variation may call for different color coding. The color coding may also include coding by shape for color impaired users.

As can best be seen by reference to FIG. 15, there are two principle horizontal planes A-A and B-B. The planes of connection are color or/and shape coded so that, by matching colors, appropriate connections can be made (orange to orange, blue to blue, etc.). Here, green, blue, red, orange and brown connectors may be used for the several planes. Some connectors may have multiple connectivity and may have multiple colors as a result to allow the user to see that they may be connected to a variety of other letters. Similarly, different planes may have different connection types so as to reduce confusion further. Also there may be two vertical or two horizontal planes as shown with different types of connectors. Examples are where lowercase letters are preceded with o, v, w or b.

Referring to FIG. 6, a first character 10a is equipped with a female attachment 12a. Character 9a is equipped with a male attachment 11a. In this way it can be seen that all female vertical attachments point right and all male vertical attachments point left. The third horizontal plane allows for the production of tails 14a. Vertical connectors 155 having upward facing male connectors 156 connect with downward facing female connectors 157 and lateral connectors 158. These tails may be extended as desired. The tail may be used as a base for the entire cut out formed from using the invention.

As can be easily seen, additional horizontal and vertical planes may be added without departing from the invention as set forth with other downward facing members.

Close examination shows that horizontal connectors 12a and 11a are of a different size than vertical connectors 156 and 157 which serves to keep the horizontal and vertical connections from being confused. In addition, coloring or shaping is used to distinguish whether a connector is left or right oriented and to orient a letter to the appropriate connector type. In fact, the entire letters are designated separately, preferably by design or color or both so that the user may select by view of the entire letter whether the letter is appropriate to the word to be cut.

As can best be seen by reference to FIG. 6, many characters have an interior space 95 and describe an entrance 13a to said interior space 95. As can best be seen by reference to FIG. 6, this space 95 when traced by stylus or cutting tool allows the rendition of a fully cut article without lifting the wire cutting tool. In this way the interior surface 29a and exterior surfaces 30a of characters 1a having an interior space 16 may be cut.

Each of the members has one or more holes or affixing means (159) for joining that character in a mounted position on a block of material to be cut. This material may be an easily cut wood, plastic, aerated plastic, plastic foam or similar material by using a jigsaw, laser, hot wire cutter, or other cutting device depending on the material to be cut. In the embodiment disclosed herein, it is envisioned that, exclusively, a hot wire cutter would be used to cut plastic foam.

In one embodiment, the characters are all stored electronically in a data base. The database functions using the following process:

1) Letter are stored which when combined make words;

2) Characters are associated with codes or pictures which may be added to the words;

3) A user enters the word to be described and the select the characters which need to be added in order to complete the word from a list of special characters;

4) The computer then selects from the stored letters and characters and joins the appropriate characters internally or the letters are associated with color or other codes or numbers which appears on the characters;

5) The computer displays (visibly or internally) the codes or numbers with or without the characters in the order in which they are to be used;

6) The user assembles the characters to be used from part 4 or the computer assembles the characters;

7) Cuts are made according to the template in order to form Plastic foam cut out letters.

As can be seen the form created by connecting the various characters 1a may be mounted by way of pins through holes 159 into the aerated plastic foam blocks to hold the form in a fixed position relative to the Plastic foam block.

The characters (1a) should be of such a depth as to allow easy mounting with pins. The pins (20) should be of such a depth to penetrate the underlying aerated plastic. They should also be sufficiently thick to make the interlocking connectors hold snugly. An adequate depth is 1/16 to 1/8 of an inch. Thicker or thinner depths would be desirable depending on particular use. The characters should be made of an appropriate material to resist the heat of the cutter.

Characters 154 through 173 in FIG. 1 show the use of “free floating” characters. These may be placed anywhere along a form to add additional artistic touches to the form created. By placing these and attaching them rigidly adjacent to the form made with other connections.

First Cutting Table

The hot wire cutter shown in FIGS. 2 and 2a and 14 may be modified by adding a sorting bin 323. The bin 323 may then be raised to a desired angle relative to the otherwise perpendicular wire 400.

In the embodiment shown in FIG. 14 there would be 40 drawers 201-214 are numbered for letters or there could be additional drawers which would be coded, preferably by colors with associated shapes for people with colored impaired vision as with the letters themselves so that the different versions of letters necessary could be sorted separately. In this table rows 201-204 could be in different colors with the colors showing on the sides and back of the box. The rims 215 at the bottom of each row would preferably be raised so as to hold the letters in place.

FIG. 14 shows an alternative where the rear portion is a rack 223 which could be raised to give more table space. A wire which may be heated is fitted into the table. A cover may close all of the letters. The slots may be numbered so as to better allow the letters to be tracked. These may show not only the color of the letters, but also may show how many of each letter is desired. The gathering stations shown allow for the letters to be quickly placed for later sorting.

The table has a drawer 230 which can hold pins or extra letter or characters. Folding legs fold under the rim 232 of the table for shipment. The top may fold over onto the table top 414.

Second Cutting Table

The table itself, shown in FIGS. 2(a) and 2(b), 314 and 320 may have several novel features, not present in the prior art. The removable cutting arm 200 allows for the cutting table to be folded and to be more portable. There is also taught a unique wiring mechanism, shown in FIG. 19 providing for a longer arm as well as variable temperature. In order to allow this greater portability, the hot wire for the cutter travels through the rod 200 from a male arm plug 401 which fits into a female arm plug 412. The female arm plug 412 is preferably made by the hole in the table top. The insulated wire is wired to a transformer 405 receiving power from a power source, here a receptacle by way of a plug 406. Electricity passes through an insulated wire 420 through the arm 200 to a conductive spring 407. This spring 407 attaches to the Nichrome or similar material cutting wire 408 which runs down to the ground bolt 410 for the system. Bolt 410 is electrically grounded. The arm itself is insulated from the internal wire. The point where the spring joins the insulated wire or where the spring joins the cutting wire is a removable connection also. This allows for the arm to be disconnected from both the cutting wire and from the receptacle so that it may be completely removed. The loop 409 in the wire allows it to be slid on and off of the bolt 410 so it may be removed just as the arm 200 may be plugged into the female arm plug 412.

To hold the arm at height a break 421 fits between the power source and the female arm plug 412.

Because the table may cut thick sheets or the fine cuts desired when using the template, a switch 411 with a built in rheostat to control the electrical flow and therefore the temperature of the wrie (not shown except as a part of the switch 411) is used so that the wire 408 may have the heat adjusted. Color coding or numeric temperature display may be a part of the rheostat so that the user will have an approximate knowledge of the temperature setting by looking at the color or numeric display of the rheostat. The switch has a sliding member 415 for adjusting the temperature of the wire 408 as shown in FIG. 2(a).

FIG. 2(a) also shows that the table has an arm hole 412 for the arm 200 and a wire hole 413 for the wire 408 so that the hook ups described above for these may be below the table surface 414.

The Spindle

One major advance over the known prior art is the advanced cutting system for simplifying the cutting of script or block names from interlocking templates utilizing a wire cutter including a table specifically designed for this purpose and for containing letters of appropriate size without interfering with the view. In addition, since a script template as previously described, is used which has multiple versions (in some cases four or more) of a single letter, a color coding system has been developed as a part of the system to allow easy association of the letters and easy selection of the letters. Association is the joining of the proper version of a letter in the series of letters forming a word. The selection is the selection of the letters from the trays 416 which form a part of the spindle upon which the letters are held. The spindle 417 is movable on the table to be brought in close proximity when necessary and then moved out of the way. This may also be accomplished by having the spindle mounted separately from the table itself. The spindle revolves so that letters on any side may be reached by the user. Rack compartments 418 are provided on the spindle so that each letter in all of it's forms or in many of its forms may be placed in separate compartments. Additional rack compartments are provided for holding the fanciful characters which can be used to decorate the words.

While a longitudinal rack may be used instead of the spindle shown in FIGS. 2a and 3, this is less desirable for two reasons. First, the length of the table top 414 would have be such that the letters could be reached and, more importantly, the views the customers would have would be diminished. Since the product has a great novelty value, the spindle design is desired. In FIGS. 2(a) and (b) a spindle supports a rack with several shelves to hold the different letters. The shelves are separated into slots to receive at least the 24 letters of the alphabet as well as other characters in other shelves or slots.

The design of the table is such that the letters are within easy reach for someone sitting at the table.

Mounting Tool

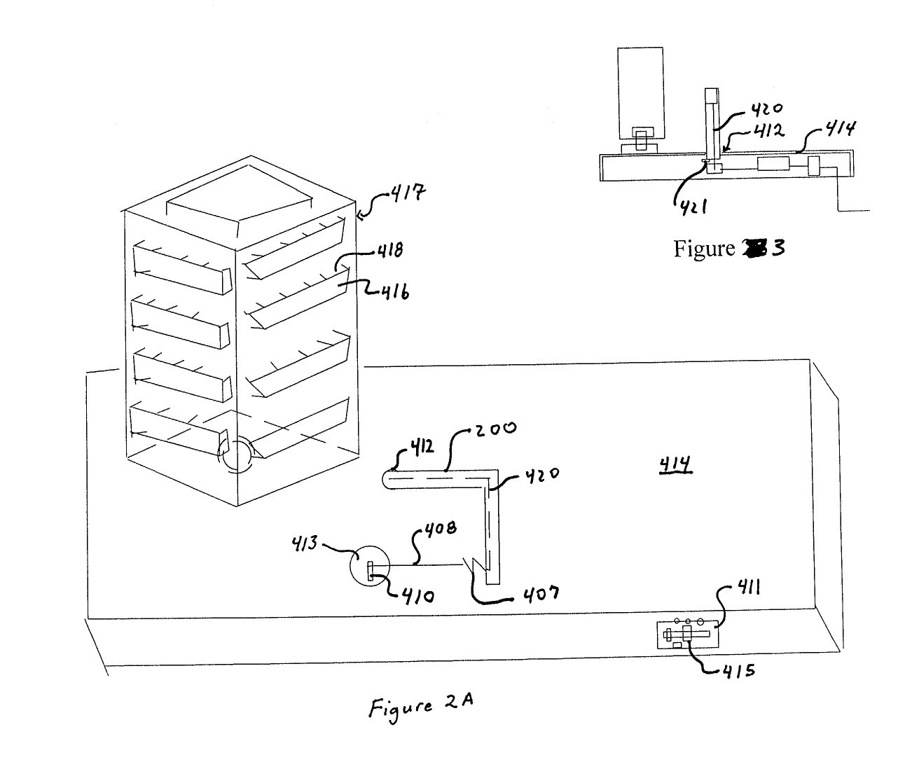

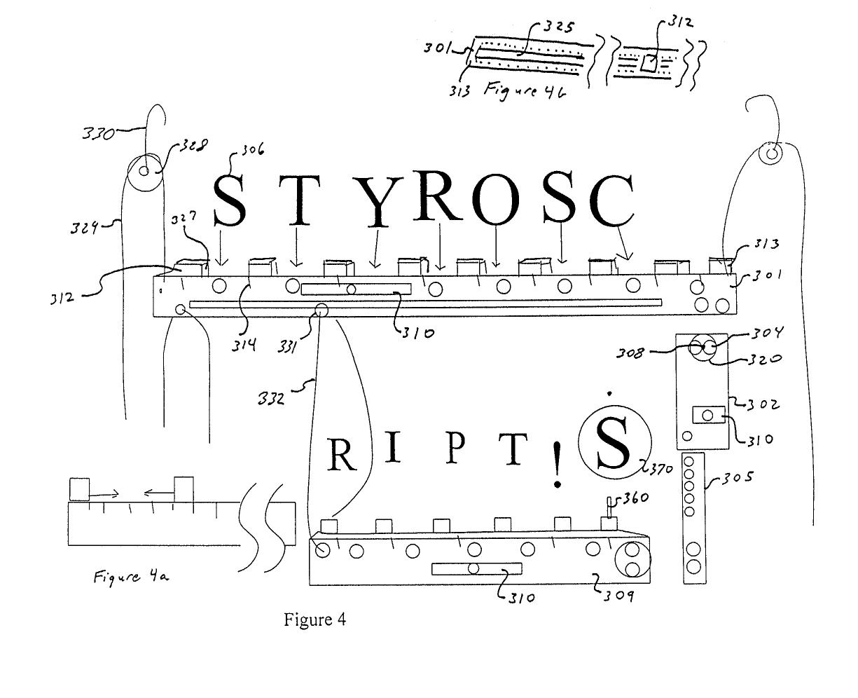

As can best be seen by reference to FIG. 4 and alternatively in FIGS. 16-18 one invention comprises a device for mounting and spacing letters in such a way that the letters may be mounted onto a surface. The purpose of this is to allow for block letters to be spaced. For an industrial sign to be produced and hung, this would be helpful. The spacing for such a building or roof mounted sign could, thereby, be set up and checked on the ground and mounted in the appropriate location without a great deal of time being spent on technical measurement or mounting above the ground level.

Spacers 312 are provided in an indention 325 and each spacer allows for a pin to be pushed through a sidewall 327 in order to affix the position of a Plastic foam letter 306 in place against a spacer. Since the inceptions and walls are on either side, the letter may be fixed between to spacers on either side.

These side walls 327 through which a pin is driven may either be peaceable walls or may have holes provided for this purpose.

As can be seen the spacers are mounted on vertical mounting boards 301 or horizontal mounting boards 302 which are connected by way of connecters 303 and 304 on the vertical and horizontal component respectively. As shown in FIG. 4 at least one of the connecters, in this case 304 is mounted on a compass 320 which is mounted on a pivot 308 so that the board may be at an angle one to another. The shape of the spacer 312 may slant either forward or back in order to have the letters mounted at a desired depth or angle.

A second row of letters may be connected onto a second vertical mounting board 309 on the level below the level of the first vertical mounting board 301.

A level 310 is provided on the vertical mounting board 301 so that the letters may mounted at the appropriate level.

An end spacer or spacer stop 313 or end block may be provided in order to hold the spacers in place and the end spacers may be slid internally in order to fix the location of the spacers 312.

Graduated markings 314 along the vertical mounting boards 301 and 309 and horizontal mounting boards 302 allow for the precise location of the spacers. The length between horizontal boards 301 and 309 may be varied with vertical spacers 305.

The invention may be hung from a roof by hooks 330 having a pulley 328 having a line 329 from the board 301 to the user or a tie down on the other end of the pulley. Similar secondary lines 332 can support the lower board 309.

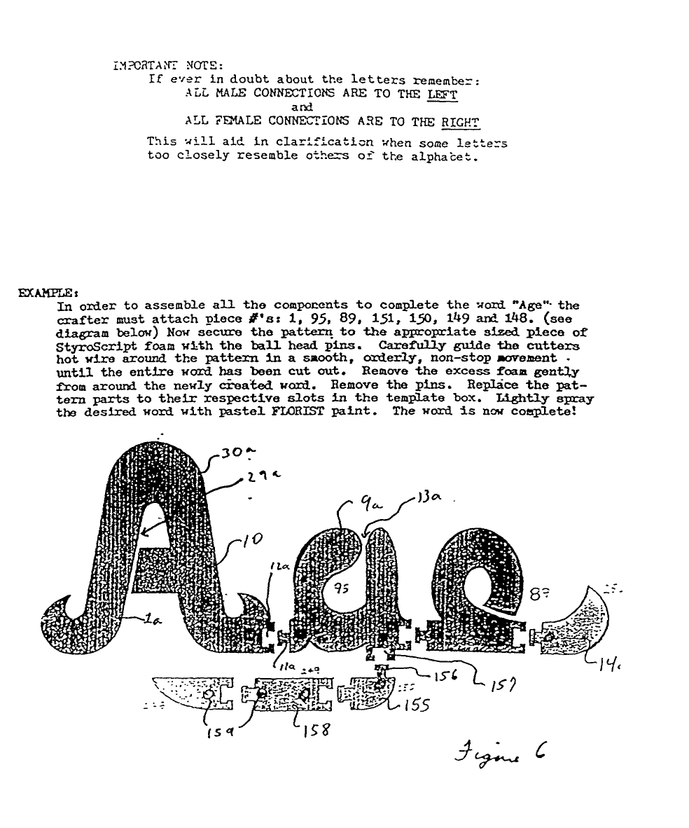

Because different letters will require a different spacing as shown in FIG. 17 by using multiple spacers or single spacers mounted in a particular location the invention can be used with the series of directions which would tell how many spacers to put between each letters in order to have them spaced out at the desirable spot. Also the spacers would have to be an appropriate size in order to allow this to be done.

Also as shown in FIG. 17 several vertical mounting boards are latched together using latches 350. In addition the vertical mounting board may receive spacers which are slid in place and then retained against the mounting board utilizing retaining screws as shown in FIG. 4. The spacers may slide within groove 325 provided therefore, preferably c bend grooves as shown.

The spacers may slide all the way into the vertical mounting board and may be pulled out as necessary in order to have letters properly spaced and where spacers are not needed they may be pushed in and recessed into mounting board.

In this way it can be seen that the purpose of the invention is to provide a platform having a means for spacing letters to be mounting on the platform or shapes in lieu of letters or characters lieu of letters on the platform in such a way that the spacing may be perfected without having to measure the distance of each part from one another.

A pin 360 in the top of one or more of the brackets 312 can receive a trademark 270 or other three dimensional character and hold it relative to the horizontal boards. Similarly, grooves could receive a three dimensional character which fit within the groove. Glue, tape, or the like could be used to hold the characters in place against the sides 327 or tops of the brackets 312.

Treatment of Letters

The invention further envisions a method of treating the Plastic foam materials in order to partially melt the Plastic foam product produced. Proper solvents include acrylic resin, aromatic hydrocarbons, ketones, although any solvent of Plastic foam products properly diluted would be acceptable. A latex based sealer is then used in order to seal the Plastic foam products.

In this case, the invention is first sprayed lightly with the proper solvent material. After the solvent has acted to partially dissolve the cutout Plastic foam, excess solvent is removed.

Alternatively, the Plastic foam product may be treated by coating with a latex on concrete sealer to give a hardened or solid looking effect without a substantial gain in weight.

For one of the principle embodiments, the sealer is used in order to harden the plastic foam word so that the word may be put in a location exposed to the elements. A part of the system is a rack to allow the words to be held while the coating dries as shown in FIG. 20. The coating may including coloring or the coloring may be added, as by paints, at a later time.

One of the elements of the invention is a specialized coating mixture which is a combination of silica granules or sand granules and a concrete calcium carbonate type matrix.

The inventive element being the approximate consistency of the granule size and the fineness of the granule size meeting the specifications that it may be spread, sprayed or painted and leave an even coating versus the normally rougher coating found with other concrete coating products.

The coating may be a latex or water based coating or have some other base so that it will not dissolve the aerated plastic foam.

A method is disclosed for treating plastic foam blocks, preferably in the shape of letters, in order to allow those blocks to be utilized in an outdoor environment for displays. The method comprises the steps of (1) Cutting the plastic foam block to the desired shape;

(2) Painting the plastic foam block with concrete exterior paint on at least one surface but preferably on all but one surface or all but part of one surface.

(3) Applying at least one second coat in order to maximize the protection;

(4) Attaching the blocks utilizing a cement such as LIQUID NAILS or similar outdoor fastening cement at the desired location by applying the cement to the portion which is exposed and not painted.

Because the environmentally protective sealant used is typically thick, it may have to be either diluted with several coats applied or applied thickly. To remove bubbles, it is envisioned that the letters will vibrated on the table shown in FIG. 20. As can be seen by reference to FIG. 21, the process of removing the bubbles and applying the exterior sealant is accomplished on a rack 230 by supporting the letters on pins 231 which come off of vertical ties 232 and horizontal ties 233. Excess sealant passes through the spaces within the grid formed by ties 232 and 233. This grid is placed on a table 234. The table 234 has a pan 238 which drains into a drain 236 which can drain into a bucket to recycle the fluid. The rack 230 rests on side rack supports 239.

It is further an invention to take the steps set forth above and add the step of applying an exterior latex paint of the desired color for the blocks so treated.

It is further technique disclosed herein to use a knife to cut away any excess or undesired paint either to return the original shape of the object or in order to expose some underlying plastic foam purposes of using a glue to attach it at the desired location directly to the plastic foam.

This technique disclosed, when used with the common letters, allows for a plastic foam sign to be erected in place of a more expensive plastic or neon type exterior sign.

It is understood that any coating which provided a sufficiently durable exterior surface would be permissible as well as any other means of attachment.

However an exterior glue such as that disclosed is best and the material must be one that will not degraded the underlying plastic foam to an undesirable extent.

In practice, the plastic foam letters are cut to the desired shape and then treated with concrete sealer either leaving one side exposed or then cutting away sealer in order to expose the side.

This is preferably done with two coats in order to make sure that sufficient coverage is provided and specific sufficient structural strength is provided to the underlying concrete.

Because the color is typically not a desirable color that you obtain and because the finish is usually not a typical finish the next step is to apply a latex type paint although another exterior paint would be acceptable as long as it would sufficiently bond to the concrete sealer or other comparable products.

1. A device for organizing templates for forming words from individual characters which when assembled display script writing comprising.
(a) a set of at least two characters for forming a template for cutting out Plastic foam wherein at least one first character is an incomplete template for a single letter and at least one second character is a finishing piece for completing the first character so that the combination of the at least one fist character and at least one second character forms a completed character;
(b) a first connecting means attached to said at least one first character for joining said at least one first character to another character;
(c) a second connecting means attached to said at least one second character for joining to said first connecting means;
(d) a coding means for identifying which first connection means attaches to said second connecting means.

2. The invention of claim 1 wherein the coding means further comprises a series of codes for identifying characters having a first connecting means with appropriate characters having second connecting means.

3. The invention of claim 1 wherein the coding means is a first color or number on the first connecting means corresponding to an identical first color or number of the second connecting means.

4. A method for preparing signs out of plastic foam from a block comprising the steps of;
(1) Cutting the plastic foam block to the desired shape;
(2) Painting the plastic foam block with at least one coat of an environmental resistant sealant on at least one surface so that the plastic foam is protected against the elements and minor abrasions by the environmental sealant;

5. The invention of claim 4 further comprising the steps of:
(a) vibrating the letter while the sealant is applied to remove excess paint;
(b)sanding away any excess or undesired paint either to return the original shape of the object or in order to expose some underlying plastic foam purposes of using a glue to attach it at the desired location directly to the plastic foam.
(c) Attaching the blocks utilizing a tacky cement such as LIQUID NAILS or similar outdoor fastening cement at the desired location by applying the cement to the portion which is exposed and not painted.
(d) applying an exterior latex paint of the desired color for the blocks so treated.

6. The method of claim 5 further comprising the steps of:
(a) Applying a sufficient amount of solvent to dissolve only the outer surface of said Plastic foam so as not to affect the underlying shape;

7. The method for treating Plastic foam set forth in claim 4 comprising of the following additional steps:
(a) Coating the Plastic foam with a latex based sealant to give the product a latex finish.

8. The invention of claim 4 further comprising at least one letter made out of plastic foam and further comprising a coating on at least one side of the letter which coating is resistant to twisting, warping, bowing and splitting so that when the at least two letters are aligned it forms a sign.

9. The invention of claim 4 wherein the environmental sealant further comprises a concrete sealer so that when it is mounted it can become a sign which is weather and animal resistant.

10. The invention claim 8 further comprising where at least two sides are covered.

11. The invention of claim 9 further comprising where at least three sides are covered.

12. The invention of claim 9 further comprising where at least all sides are covered.

13. The invention of claim 4 further comprising an adhesive material applied to at least one side so that the character so described may be adhered to a surface.

14. A leveler for hanging signs on a hanging surface having a face, a vertical length and a top wherein the sign is comprised of individual characters, at least one first and at least one second character, comprising:
a) A first horizontal surface having a left side and a right side for holding the at least one first character and at least one second character above the horizontal surface; and
b) at least one channel within the first horizontal surface for receiving a plurality of spacing means for providing incremental spacing between the at least first character and at least one second character.

15. The invention of claim 14 further comprising at least one vertical member having a length attached to the first horizontal surface; a second horizontal surface for holding characters and at least one vertical holding means attached to the at least one vertical member below the first horizontal surface for holding the second horizontal surface along the vertical holding member length.

16. The invention of claim 15 further comprising at least one attachment means for fixing the position of the characters between the plugs and the first horizontal surface.

17. The invention of claim 15 further comprising a first hanging means attached to the left side and the right side and wherein the first hanging means is removably attachable to the top of the hanging surface for lifting and holding the horizontal surface along the length of and against the face of the hanging surface.

18. The invention of claim 17 wherein the horizontal surface further comprises a level mounted on the first horizontal surface for adjusting the position of the first horizontal surface relative to the pull of gravity.

19. The invention of claim 18 wherein the first hanging means comprises a line having a first end and a second end and wherein the first end is attachable to the left side of the first horizontal surface and further comprises a pulley attachable to the top of the hanging surface and wherein the line second end runs through the pulley so that the position and angle of the first horizontal member may be adjusted relative to the hanging surface.

20. The invention of claim 14 wherein the at least one first character and at least one second character further comprises at least one third character and wherein the first spacing between the at least one first character and at least one second character within an individual word is different than the second spacing between the at least one second character and at least one third character and wherein the plurality of spacing means provides for the difference between the first spacing and the second spacing.

21. The invention of claim 20 wherein the spacing means comprises a plurality of plugs fitting within the at least one channel and wherein said plugs comprise a plug with a minimum width for the narrowest spacing between individual characters.
